(19) United States
(12) Patent Application Publication
(10) Pub. No.: US 2004/0114181 A1
(43) Pub. Date: Jun. 17, 2004

(54) E-mail facsimile machine to post-process an e-mail and e-mail facsimile post-processing method thereof

(75) Inventor: Young-Hoon Kim, Yongin-City (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-City (KR)

(21) Appl. No.: 10/701,551

(22) Filed: Nov. 6, 2003

(30) Foreign Application Priority Data
Dec. 16, 2002 (KR) 2002-80510

(51) Int. Cl. H04N 1/00; G06F 15/00

(52) U.S. Cl. 358/1.15; 358/402

(57) ABSTRACT

An e-mail facsimile machine to implement post-processing operations, such as deleting and forwarding an e-mail facsimile that has been sent, by using a non-standard header. The e-mail facsimile machine comprises: a mail sending unit to convert a scanned document image to an e-mail and to send the e-mail to the e-mail server, a post-processing operation adding unit to add a post-processing operation to the e-mail to be sent, a mail receiving unit to receive an e-mail from the e-mail server, and a post-processing operation implementing unit to check whether there is a post-processing operation designated in the received e-mail and to implement the post-processing operation as designated. Accordingly, the post-processing operation adding unit uses a non-standard header to add the post-processing operation to the e-mail to be sent, and the post-processing operation implementing unit checks whether there is a post-processing designated in the non-standard header of the received e-mail.

### CROSS-REFERENCE TO RELATED APPLICATIONS

This application claims the benefit of Korean Patent Application No. 2002-80510, filed Dec. 16, 2002 in the Korean Intellectual Property Office, the disclosure of which are incorporated herein by reference.

### BACKGROUND OF THE INVENTION

1. Field of the Invention

The present invention relates to an e-mail facsimile machine connected to an e-mail server to send and to receive a facsimile via e-mail, and more particularly, to an e-mail facsimile machine that adds post-processing to an e-mail to be sent to allow the e-mail to be processed after the e-mail has been received by an e-mail facsimile machine of a receiver and stored in an e-mail server, and an e-mail facsimile post-processing method thereof.

2. Description of the Related Art

Generally, an e-mail facsimile machine is a machine connected to an e-mail server that is connected to another e-mail server through the Internet, and scans a document to convert it to an e-mail to send the e-mail to a receiver using an e-mail address. An e-mail facsimile machine also receives an e-mail from a sender and prints out the e-mail. That is, the e-mail facsimile machine uses the Internet instead of a telephone wire to send and to receive contents of the document.

An e-mail facsimile machine connected to the Internet is shown in FIG. 1.

Referring to FIG. 1, e-mail facsimile machines 10 and 16 are connected to e-mail servers 12 and 14, respectively, and the e-mail servers 12 and 14 are connected to each other through the Internet. Accordingly, when the sender e-mail facsimile machine 10 sends an e-mail, the e-mail is transmitted to the sender e-mail server 12, and then transmitted to the receiver e-mail server 14 through the Internet. The receiver e-mail facsimile machine 16 receives the e-mail from the receiver e-mail server 14 and prints out the e-mail on paper.

Since such a conventional e-mail facsimile machine simply converts a document to an e-mail and sends the e-mail using the e-mail server, it does not allow the sender e-mail facsimile machine to perform an e-mail post-processing, for example, the sender e-mail facsimile machine cannot perform a post-process with respect to the e-mail that is stored in the receiver mail server after the e-mail has been received by the receiver e-mail facsimile machine.

That is, when a sender wishes to delete the e-mail that is stored in the receiver e-mail server after the e-mail has been received by the receiver e-mail facsimile machine, the sender is unable to do so because the sender e-mail facsimile machine is not enabled to perform post-processing, such as deleting an e-mail stored in the receiver e-mail server.

### SUMMARY OF THE INVENTION

An aspect of the present invention has been developed in order to solve the above problem in the prior art. Accordingly, one aspect of the present invention is to provide an e-mail post-processing machine to allow a sender to process an e-mail after the e-mail is saved in a receiver e-mail server after the e-mail has been received by a receiver e-mail facsimile machine.

Additionally, another aspect of the present invention is to provide an e-mail facsimile post-processing method to control a post-processing of an e-mail that has been sent by a sender.

Additional aspects and advantages of the invention will be set forth in part in the description which follows and, in part, will be obvious from the description, or may be learned by practice of the invention.

The above and/or other aspects and advantages of the present invention are achieved by providing an e-mail facsimile machine capable of post-processing that comprises a facsimile machine connected to an e-mail server to send and to receive a scanned document image using an e-mail. The e-mail facsimile machine comprises: a mail sending unit to convert a scanned document image to an e-mail and to send the e-mail to the e-mail server, a post-processing operation adding unit to add a post-processing operation to the e-mail to be sent, a mail receiving unit to receive an e-mail from the e-mail server, and a post-processing operation implementing unit to check whether there is a post-processing operation designated in the received e-mail and to implement the post-processing operation as designated.

The post-processing operation adding unit uses a non-standard header to add the post-processing operation to the e-mail to be sent. The post-processing operation implementing unit checks whether there is a post-processing operation designated in the non-standard header of the received e-mail. Here, the post-processing operation might be to delete the e-mail received by the e-mail server, or to forward the received e-mail to another e-mail address.

The above and/or other aspects and advantages of the invention are also achieved by providing an e-mail facsimile post-processing method, which comprises adding a post-processing operation to an e-mail to be sent by using an e-mail facsimile machine connected to an e-mail server. The e-mail facsimile post-processing method comprises: selecting an e-mail sending menu and inputting address information of an e-mail to be sent, selecting a post-processing operation of the e-mail to be sent, inputting information needed for the selected post-processing operation, and sending the e-mail to the e-mail server.

According to an aspect of the present invention the post-processing operation information inputted is recorded on a non-standard header of the e-mail to be sent.

In addition, other aspects and/or advantages of the present invention are achieved by providing an e-mail facsimile post-processing method, which comprises checking a post-processing operation of a received e-mail and implementing the post-processing operation by using an e-mail facsimile machine connected to an e-mail server. The e-mail facsimile post-processing method comprises: receiving an e-mail from the e-mail server, checking whether there is a post-processing operation designated in the received e-mail, memorizing the post-processing operation, printing out contents of the e-mail, and implementing the memorized post-processing operation.

According to yet another aspect of the invention, the post-processing operation checking method checks the non-standard header of the received e-mail.

The e-mail facsimile machine capable of post-processing according to an aspect of the present invention allows a sender to perform a post-processing operation with respect to the e-mail received by the e-mail server of a receiver and stored.

In addition, according to the e-mail post-processing method as described above, a sender is allowed to perform a post-processing operation with respect to the e-mail received by the e-mail server of a receiver and stored.

Accordingly, an e-mail facsimile machine capable of post-processing and an e-mail facsimile post-processing method, which allows a sender to process an e-mail after the e-mail has been received by the receiver e-mail facsimile machine is provided.

### BRIEF DESCRIPTION OF THE DRAWINGS

The above and/or aspects and advantages of the invention will become apparent, and more readily appreciated from the following description of the preferred embodiments, taken in conjunction with the accompanying drawings, in which:

FIG. 1 is a block diagram to show a conventional e-mail facsimile machine connected to the Internet;

FIG. 2 is a block diagram to show an e-mail facsimile machine capable of post-processing according to an embodiment of the present invention;

FIG. 3 is a flowchart to show an e-mail facsimile post-processing method when the e-mail facsimile machine shown in FIG. 2 sends an e-mail; and

FIG. 4 is a flowchart to show an e-mail facsimile post-processing method when the e-mail facsimile machine shown in FIG. 2 receives an e-mail.

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to the like elements throughout.

Hereinafter, descriptions of an e-mail facsimile machine capable of post-processing and an e-mail facsimile post-processing method will be made according to preferred embodiments of the present invention.

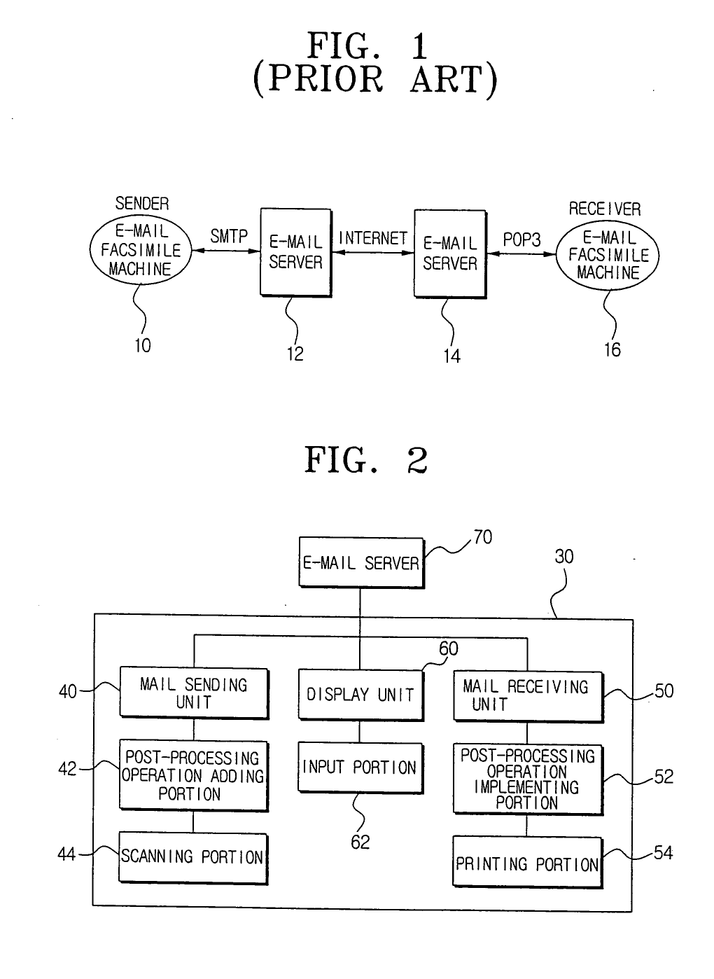

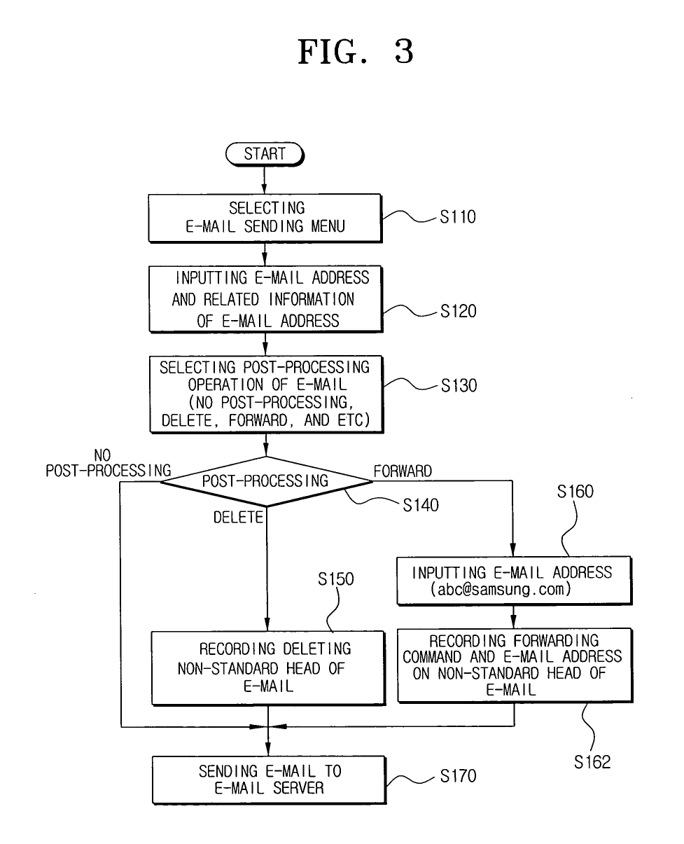

A block diagram to show an e-mail facsimile machine capable of post-processing is shown in FIG. 2.

Referring to FIG. 2, an e-mail facsimile machine 30, which includes a mail sending unit 40, a mail receiving unit 50, and a display unit 60, is connected to an e-mail server 70.

The mail sending unit 40, which scans a document to convert it to an e-mail, includes a post-processing operation adding portion 42 and a scanning portion 44. The scanning portion 44, which is identical to a general facsimile machine, reads a document to be sent by using a scanning sensor and creates image data. The mail sending unit 40 prepares an e-mail using the image data created by the scanning portion 44, and e-mail addresses input by a user. At this point, the image data is processed as content of the e-mail to be sent or as an attached file. Additionally, the e-mail address of a receiver is processed so that the e-mail address is recorded in a header of the e-mail to be sent.

The e-mail header includes information regarding how the e-mail server 70 and the e-mail facsimile machine 30, acting as a client of the e-mail server 70, process the e-mail as received and/or sent. The e-mail header is divided into a reference header and a non-standard header. The reference header of the e-mail, which is required information for the e-mail server 70 and the e-mail facsimile machine 30 to send and receive e-mail, includes: e-mail addresses of a sender and a receiver, an e-mail sending time, and the name of the e-mail server of the received e-mail. The non-standard header of the e-mail is information, which a user can add for the purpose of a special process.

The post-processing operation adding portion 42 adds a specific post-processing operation to an e-mail to be sent by a sender. By implementing the post-processing, after sending the e-mail, a sender can process the e-mail after the e-mail is received by an e-mail facsimile machine 30 of the receiver and saved in an e-mail server of a receiver. For example, the e-mail processing includes various processing operations such as deleting the e-mails stored in the e-mail server, forwarding the stored e-mail to another email address, and other operations in relation to the e-mail, which the sender is allowed to perform in relation to the sender's sent e-mail.

The post-processing operation adding portion 42 adds the post-processing operation by recording a command to implement a specific post-processing operation on the non-standard header of the e-mail header. For example, in a situation where the sender wants to delete the e-mail stored in the e-mail server, the command X-PostProcessing: delete is recorded on the non-standard header, and in a case where the sender wants to forward the received e-mail to another e-mail address, the command, X-PostProcessing: mail to: abc@samsung.com, is recorded on the non-standard header. At this time, because a selection with regard to the post-processing operation is output to the display unit 60, the sender selects a post-processing operation, as the sender wants. In addition, if the post-processing is a forwarding process, the sender is allowed to input an e-mail address through an input portion 62 attached to the display unit 60.

The mail receiving unit 50, which receives an email received in the e-mail server 70 to print out the contents of the e-mail, includes a post-processing operation implementing portion 52 and a printing portion 54.

The post-processing operation implementing portion 52 determines whether a post-processing operation is recorded on the non-standard header of the received e-mail. Upon determining that the post-processing operation is recorded, the post-processing operation implementing portion 52 processes the e-mail stored in the e-mail server 70 according to the content. For example, in a case where the post-processing operation is deleting, the post-processing operation implementing portion 52 sends a signal to the e-mail server 70 to delete the e-mail stored in the e-mail sever 70 after printing out the e-mail. Moreover, in a case where the post-processing operation is forwarding, the post-processing operation implementing portion 52 sends a signal to the e-mail server 70 to forward the e-mail to an email address recorded on the non-standard header.

The printing portion 54, which is identical to that of a general facsimile machine, prints out contents of the e-mail received through the mail receiving unit 50 on paper.

Hereinafter, in reference to FIG. 3, an e-mail facsimile post-processing method in which the above-described e-mail facsimile machine adds a post-processing operation is described.

First, a sender selects an e-mail sending menu through the input portion 62 (S110). Upon selecting the e-mail sending menu, the sender inputs an e-mail address of a receiver and other related information of the e-mail through the input portion 62 (S120).

Upon inputting the e-mail address and related information of the e-mail, the sender selects a post-processing operation of an e-mail to be sent through the display unit 60 (S130). A menu displayed on the display unit 60 includes “no post-processing”, “delete”, “forward”, or other e-mail related operations (S140).

If “delete” is selected as the post-processing operation, the post-processing operation adding portion 42 records a deleting command on the non-standard head of the e-mail (S150). Alternatively, if “forward” is selected as the post-processing operation, the display unit displays a message “please input e-mail address” where the sender inputs an e-mail address (S160). When the e-mail address is input, the post-processing operation adding portion 42 records a forwarding command and the e-mail address on the non-standard header of the e-mail (S162). Once the e-mail address is entered, the mail sending unit 40 prepares an e-mail by incorporating document information scanned via the scanning portion 44, the non-standard header created by the post-processing operation adding portion 42, and sends the e-mail to the e-mail server 70 (S170).

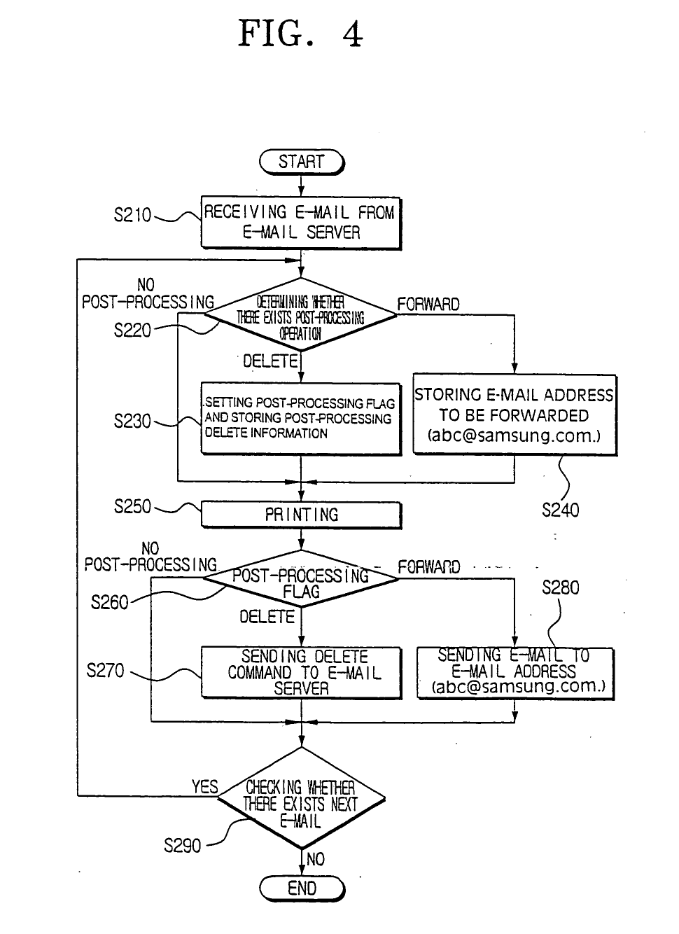

In reference to FIG. 4, descriptions will be made of an e-mail facsimile post-processing method in which the above-described e-mail facsimile machine receives an e-mail and performs a post-processing operation as requested. The commands and e-mail addresses shown in FIG. 4 are illustrative of the various email addresses and commands a sender can use.

The e-mail facsimile machine 30 determines whether an e-mail is addressed to a predetermined e-mail address of the e-mail server 70 connected thereto within a predetermined time interval.

Upon determining that the e-mail server 70 has received the e-mail, the mail receiving unit 50 receives the e-mail from the e-mail server 70 (S210).

When the mail receiving unit 50 receives the e-mail, the post-processing operation implementing portion 52 determines whether there exists a post-processing operation in the received e-mail (S220). At this point, the post-processing operation implementing portion 52 determines the presence or the absence of the post-processing by checking the non-standard header of the e-mail.

In the absence of a post-processing operation, the mail receiving unit 50 controls the printing portion 54 to perform a printing (S250), and checks whether there exists another e-mail (S290).

In the presence of a post-processing operation, the post-processing operation implementing unit 50 sets a post-processing flag and stores post-processing information. In a case where the post-processing operation is “delete”, the post-processing operation implementing unit 50 stores delete information (S230), and in a case where the post-processing operation is “forward”, the post-processing operating implementing unit 50 stores an e-mail address to where the e-mail is to be forwarded (S240).

Then, the mail receiving unit 50 controls the printing portion 54 to perform a printing operation (S250), and controls the post-processing operation implementing portion 52 to implement the post-processing operation by checking the post-processing flag after the printing (S260). For example, when the post-processing flag is “delete”, the post-processing operation implementing portion 52 sends a delete command to the e-mail server 70 (S270). When the post-processing flag is “forward”, the post-processing operation implementing portion 52 sends to the e-mail server 70 a command to forward the e-mail to the stored e-mail address (S280).

Next, the mail receiving unit 50 checks whether there is another e-mail in the e-mail server 70. Upon determining that there is another e-mail, the above-described process is repeated (S290). Upon determining that there is no other e-mail to be received, the e-mail receiving operation is completed.

The e-mail facsimile machine capable of post-processing according to an aspect of the present invention allows a sender to perform a post-processing operation with respect to an e-mail received by the e-mail server of a receiver and stored, comprising deleting the e-mail, forwarding the e-mail to another e-mail address or other e-mail related operations.

In addition, according to the e-mail post-processing method as described above, a sender is able to perform a post-processing operation with respect to the e-mail received by the e-mail server of a receiver and stored, comprising deleting the e-mail, forwarding the e-mail to another e-mail address, other e-mail related operations.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An e-mail facsimile machine connected to an e-mail server to send and to receive a scanned document using an e-mail, comprising:
a mail sending unit to convert the scanned document image to an e-mail format and to send the scanned document using the e-mail to the e-mail server;
a post-processing operation adding unit to add a post-processing operation to the e-mail to be sent;
a mail receiving unit to receive an e-mail from the e-mail server; and
a post-processing operation implementing unit to check whether there is a post-processing operation designated in the received e-mail and to implement the post-processing operation as designated.

2. The e-mail facsimile machine as claimed in claim 1, wherein the post-processing operation adding unit uses a non-standard header to add the post-processing operation to the e-mail to be sent.

3. The e-mail facsimile machine as claimed in claim 2, wherein the post-processing operation implementing unit checks whether there is a post-processing operation designated in the non-standard header of the received e-mail.

4. The e-mail facsimile machine as claimed in claim 3, wherein the post-processing operation is to delete the received e-mail located at the e-mail server.

5. The e-mail facsimile machine as claimed in claim 3, wherein the post-processing operation is to forward the received e-mail to another e-mail address.

6. An e-mail facsimile post-processing method to add a post-processing operation to an e-mail to be sent using an e-mail facsimile machine connected to an e-mail server, comprising:
selecting an e-mail sending menu and inputting address information of the e-mail to be sent;
selecting a post-processing operation of the e-mail to be sent;
inputting information needed for the selected post-processing operation; and
sending the e-mail to the e-mail server.

7. The e-mail facsimile post-processing method as claimed in claim 6, wherein the post-processing operation information inputted is recorded on a non-standard header of the e-mail to be sent.

8. An e-mail facsimile post-processing method using an e-mail facsimile machine connected to an e-mail server, comprising:
receiving an e-mail from the e-mail server;
checking whether there is a post-processing operation designated in the received e-mail via an e-mail facsimile machine connected to the e-mail server;
memorizing the post-processing operation;
printing out contents of the e-mail; and
implementing the memorized post-processing operation.

9. The e-mail facsimile post-processing method as claimed in claim 8, wherein the post-processing operation checking operation checks a non-standard header of the received e-mail.

10. The e-mail facsimile post-processing method as claimed in claim 8, wherein a sender is allowed to perform the post-processing operation to the e-mail after the e-mail has been received and stored by the e-mail server of a receiver.

11. The e-mail facsimile machine as claimed in claim 1, wherein the post-processing operation adding unit allows a sender to perform a post-processing operation to the e-mail after the e-mail has been received and stored by the e-mail server of a receiver.

12. An e-mail facsimile machine connected to an e-mail server, comprising:
a mail sending unit to scan a document to convert the document to an e-mail and to allow addition of a specific post-processing operation to the e-mail to be sent by a sender; and
a mail receiving unit that receives e-mails received by the e-mail server to print out the contents of the e-mail and perform the post-processing operation.

13. The e-mail facsimile machine as claimed in claim 12, wherein the mail sending unit further comprises:
a post-processing operation adding portion to add the specific post-processing operation to the e-mail to be sent by the sender; and
a scanning portion to read a document to be sent and to create an image data.

14. The e-mail facsimile machine as claimed in claim 13, wherein the mail sending unit prepares the e-mail using the image data created, and e-mail addresses input by the sender.

15. The e-mail facsimile machine as claimed in claim 13, wherein the post-processing operation adding portion adds the post-processing operation by recording a command to implement the specific post-processing operation on a non-standard header of an e-mail header.

16. The e-mail facsimile machine as claimed in claim 12, wherein an input portion is attached to the display unit to allow a user to enter information.

17. The e-mail facsimile machine as claimed in claim 12, wherein the mail receiving unit further comprises:
a post-processing operation implementing portion to determine whether the post-processing operation is recorded on a non-standard header of a received e-mail; and
a printing portion to print out contents of the e-mail received via the e-mail receiving unit.

18. The e-mail facsimile machine as claimed in claim 17, wherein upon determining that the post-processing operation is recorded, the post-processing operation implementing portion processes the e-mail stored in the e-mail server according to the content of the e-mail.

19. A method of post-processing an e-mail facsimile, comprising:
selecting a post-processing operation of an e-mail to be sent;
recording a command in response to the selection of the post-processing operation on a non-standard header of the e-mail;
scanning a document;
incorporating the command, the scanned document, and the non-standard header;
sending the e-mail to an e-mail server;
setting a post-processing flag and storing the post-processing information via a post processing operation implementing unit; and
implementing the post-processing operation by checking the post-processing flag.

20. A method of post-processing an e-mail facsimile, comprising:
determining whether a post processing operation exists in a received e-mail by checking a non-standard header of an e-mail;
setting a post-processing flag and storing the post-processing information; and
implementing the post-processing operation by checking the post-processing flag.

21. A mail receiving unit in an e-mail facsimile machine, comprising:
a post-processing operation implementing portion to determine whether a post processing operation is recorded on a non-standard header of a received e-mail; and
a printing portion to print out contents of the e-mail received.

22. A mail sending unit in an e-mail facsimile machine, comprising:
a post-processing operation adding portion to add the specific post-processing operation to an e-mail to be sent; and
a scanning portion to read a document to be sent and to create an image data.
